(19) United States
(12) Patent Application Publication
(10) Pub. No.: US 2013/0155094 A1
(43) Pub. Date: Jun. 20, 2013

(54) MOBILE TERMINAL HAVING NON-READABLE PART

(71) Applicant: Myung Hwan Ahn, Seoul (KR)

(72) Inventor: Myung Hwan Ahn, Seoul (KR)

(21) Appl. No.: 13/814,019

(22) PCT Filed: Aug. 2, 2011
(86) PCT No.: PCT/KR2011/005678

§ 371 Date: Feb. 4, 2013

(30) Foreign Application Priority Data
Aug. 3, 2010 (KR) 10-2010-0074823

(51) Int. Cl. G09G 3/20

(52) U.S. Cl. CPC G09G 3/2003
USPC 345/592

(57) ABSTRACT

A mobile terminal having a non-readable part and includes: a control unit for controlling a function of a program; a storage unit in which various data are stored; and a display unit for displaying the digitalized document through the control unit. The display unit includes a readable part which enables a user to clearly read the document and a non-readable part in which the user is not able to read clearly by having the clarity different from the clarity of the readable part. Accordingly, the mobile terminal of the present invention enables the user to easily read the electronic document without missing sentences by improving the readability for the electronic document in the moving state.

### CROSS-REFERENCE TO RELATED APPLICATION

This application is a PCT/KR2011/005678 filed on Aug. 2, 2011 which is based on, and claims the benefit under 35 U.S.C. §119(a) of Korean Patent Application No. 10-2010-0074823, filed on Aug. 3, 2010, the entire disclosure of which is incorporated herein by reference for all purposes.

### BACKGROUND

1. Field of the Invention

The disclosed embodiments relate generally to portable electronic devices that support user exercise routines, and more particularly, to portable electronic devices with displays that support user exercise routines.

2. Description of the Related Art

As portable electronic devices, that is, mobile terminals become more compact, and the number of functions performed by a given device increase, it has it has become a significant challenge to design a user interface that allows users to easily interact a multifunction device. This challenge is particularly significantly for mobile terminals with touch-sensitive displays, which have smaller screens than desktop computers.

Recently smart phones and e-books become popular and used widely. Accordingly, users who read electronic documents in a mobile terminal while they move become growing more and more. However a lot of people are accustomed to reading paper documents. Therefore, a lot of people are suffering from eye fatigue due to the small displays of mobile terminals when they read a newspaper, a book, a document and so forth In many cases, such electronic documents on the displays of mobile terminals are read on buses, subway trains and so forth. In this case, it is difficult to read and concentrate attentively on electronic documents on small displays due to the distracting surroundings and the shaking of the vehicles. Therefore, it is difficult to read sentences continuously and, when distracted, it takes a long time to find the last read sentence again.

### SUMMARY

The disclosed embodiments relate to generally mobile terminals with a non-readable unit and a readable unit to enable users to easily focus on and read an electronic document even while users move.

The disclosed embodiments relate to a mobile terminal having a non-readable part that enables a user to easily read an electronic document while in a moving state by performing a control for improving readability of a display part for displaying the electronic document. The disclosed embodiments includes: A storage unit storing an electronic document file; a display unit displaying the electronic document file; a control unit controlling the display of the electronic document file; Wherein the control unit controls the electronic document file to be displayed with a readable part able to be read clearly and a non-readable part unable to be read clearly.

Accordingly, the mobile terminal of the present invention enables the users to easily read electronic documents without missing sentences by improving the readability of the electronic documents in a moving state.

In one general aspect, a display unit (200) comprises a readable part (210) and a non-readable part (220). The readable part displays a document so that a user can clearly read the document. The non-readable part has a darkness clarity which is darker than that of the readable part. The non-readable part displays the document so that the user can not clearly read the document. The non-readable part has darkness which is darker than the darkness of the readable part.

Other features and aspects will be apparent from the following detailed description, the drawings, and the claims.

### BRIEF DESCRIPTION OF THE DRAWINGS

FIG. 1 is a diagram illustrating an example of a mobile terminal in accordance with some embodiments;

FIG. 2 is a diagram illustrating an example of an enlarging area of a readable part in accordance with some embodiments;

FIG. 3 is a diagram illustrating an example of enlarging letters of a readable part in accordance with some embodiments;

FIG. 4 is a diagram illustrating an example of movement of a readable part by scrolling in accordance with some embodiments;

FIG. 5 is a diagram illustrating another example of non-readable part in accordance with some embodiments;

FIGS. 6 and 7 is a diagram illustrating another example of using a mobile terminal in accordance with some embodiments in accordance with some embodiments;

FIGS. 8 and 9 is a diagram illustrating another example of a mobile terminal in accordance with some embodiments;

FIG. 10 is a flowchart illustrating an example of executing a manual and automatic mode terminal in accordance with some embodiments;

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. A mobile terminal according to the disclosed embodiments is a portable electronic device, including a PDA, a cellular phone, an e-book, a smart phone, a laptop computer, a tablet PC such as an iPad or iPod.

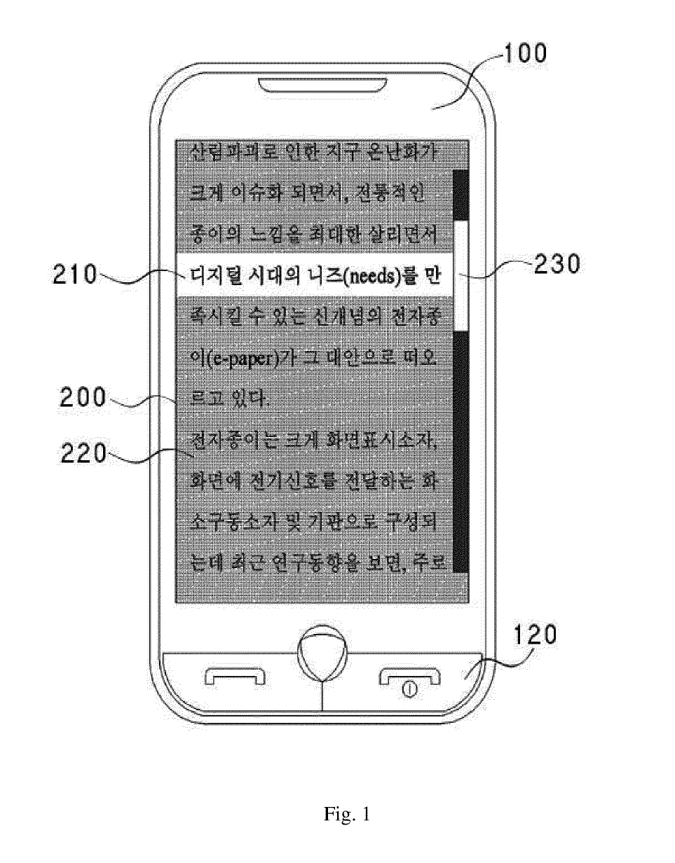

FIG. 1 is a diagram illustrating an example of a mobile terminal in accordance with some embodiments. A mobile terminal in accordance with some embodiments includes a main body 100, a button for control 120, a control unit for controlling a function of a program (omitted), a storage unit in which various data are stored (omitted) and a display unit for displaying the digitalized document through the control unit. The control unit is operable to drive various programs or control communication functions incorporated into the mobile terminal with a CPU as the center. The storage unit comprising of RAM, flash memory etc., saves various data for driving the mobile terminal.

In some embodiments, the display unit may comprise a readable part which enables a user to clearly read the document and a non-readable part in which the user is not able to read clearly by having a clarity different from a clarity of the readable part. In other words the readable part is a part that displays specific letters clearly in order to be easily read. The non-readable part is a part that displays specific letters unclearly to be more difficult to read in comparison with the readable part.

Generally, a display unit must be displayed clearly in order for electronic documents to be easily and conveniently read. However, recent technologies, such as LED, OLED, electronic ink and so forth, have many limitations with their brightness performance. In these bright conditions, if the unread area's clarity and visibility is lower, a reading part has higher clarity and visibility so that we can concentration on the reading part more.

The users can definitely find a part which he reads now because he can read sentences with moving the readable part 210. Preferably, the non-readable part may include specific letters and its background, that is, its environment, whose clarity and visibility are lowered.

Usually in a black-and-white display, a letter is black with low brightness and an environment, which is not a letter, is white with high brightness. Therefore, if the environment part of the non-readable part is dark and the environment part of readable part is bright, a user can read the letters of the readable part with complete concentration.

Usually in a color display, the display 200 has color information as well as brightness information. Therefore, if a color difference between an environment part and a letters part of the non-readable part 220 is smaller than that of the readable part, a user can read letters of the readable part 210 with complete concentration.

If the environment part's color and the letters part's color of the non-readable part 220 is the same, it is impossible to see the letters of the non-readable part 220. In this case, although it is still easy to read the letters part of the readable part, reading becomes hindered and difficult because it is impossible to differentiate the letters from the readable part 210.

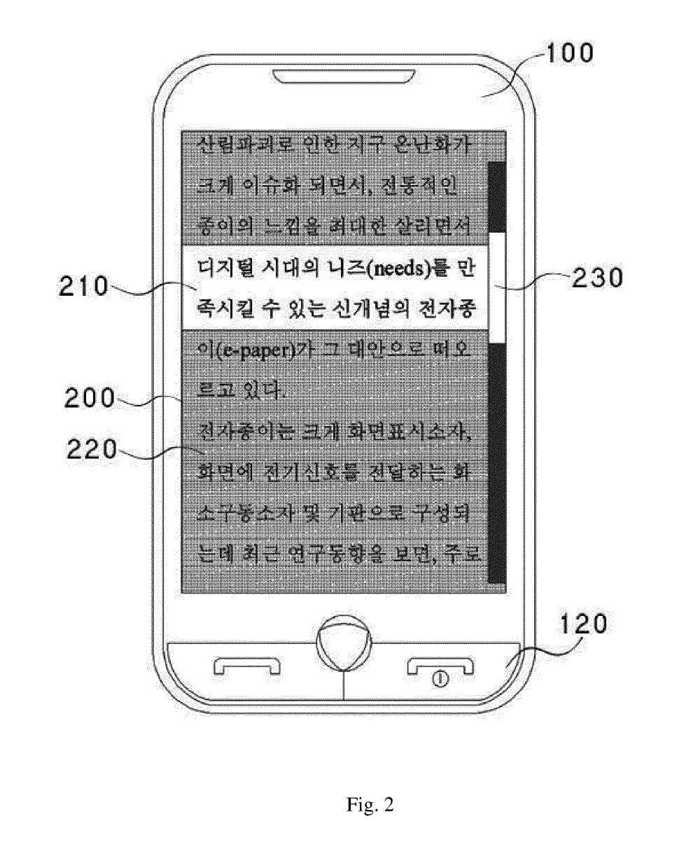

In the case that reading the readable part 210 is hindered and difficult due to one row, the readable part 210 may comprise a plurality of rows according to FIG. 2. Also, a method for moving the readable part 210 is that the readable part 210 can move each row or scroll manually.

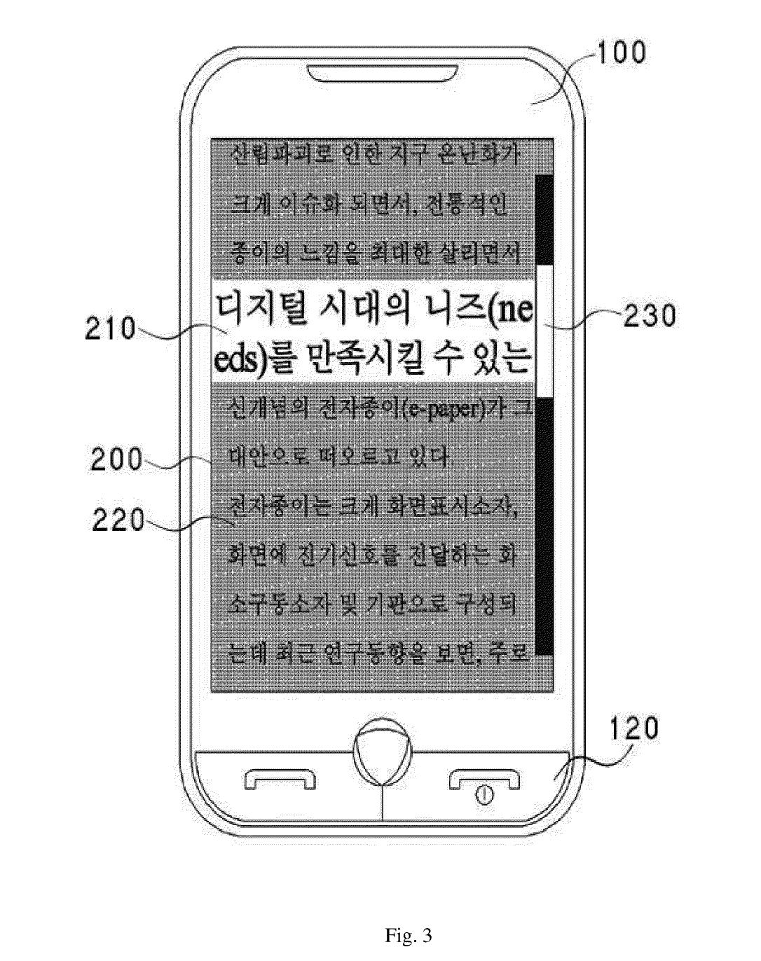

In FIG. 3, letters in the readable part 210 are bigger than those of the non-readable part 220. Therefore when letters in the readable part 210 are read, a user may feel more comfortable with bigger letters. In the case that the readable part 210 cannot be displayed in one row due to the largeness of the letters, the readable part 210 may be displayed in two rows.

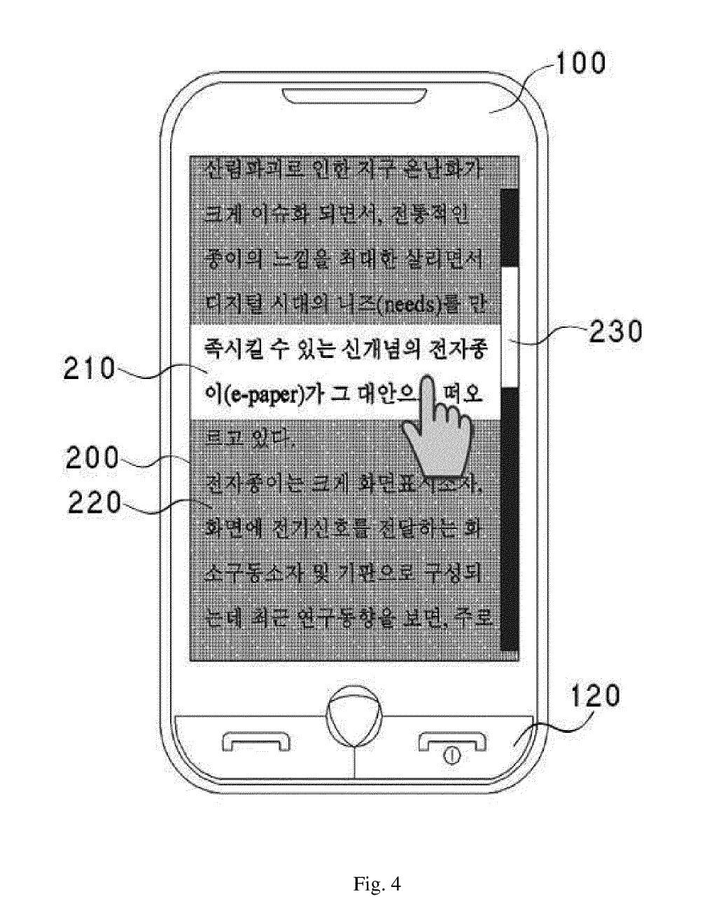

The readable part 210 may be moved by pushing a button 120. However, with regard to a touch screen of the display, a row or part on which a user's finger touches becomes recognized as the readable part 210 as FIG. 4. In this case, when a row or part on which a user's finger touches moves, the readable part 210 may move together in accordance to the row or part.

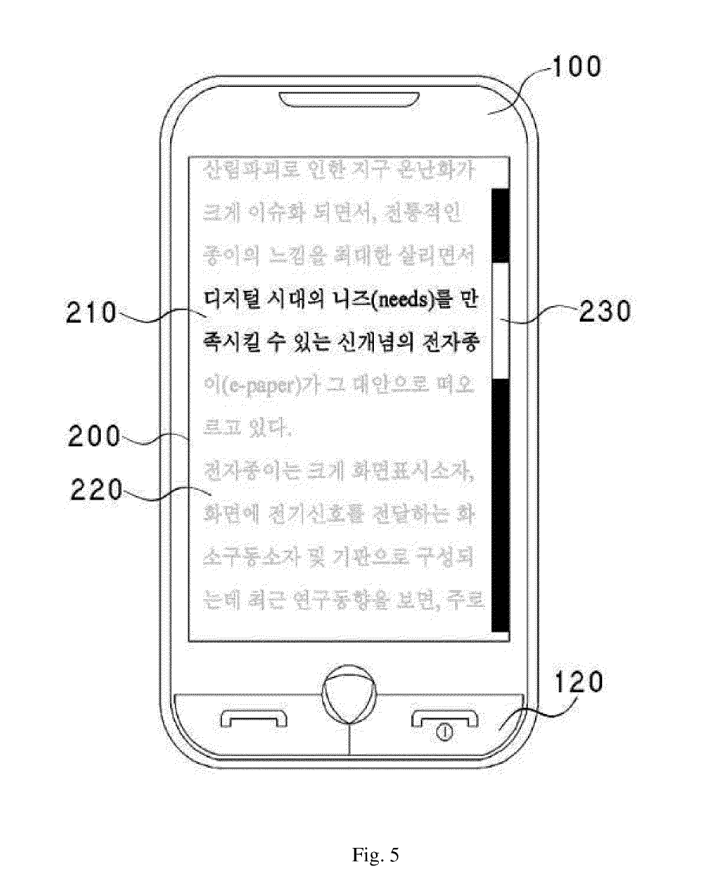

The non-readable part 220 may be displayed with reduced color difference between the environment part and the letters part, and also be displayed with the letters part color similar to the environment part color as FIG. 5. Clarity and visibility may be lowered by lowering a brightness of the letters part for a black-and-white display.

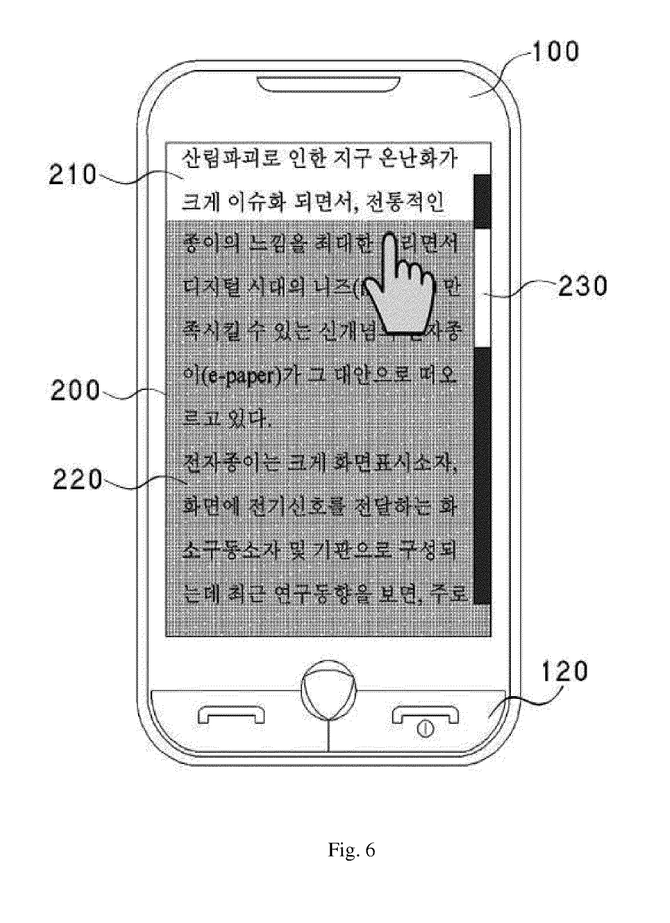

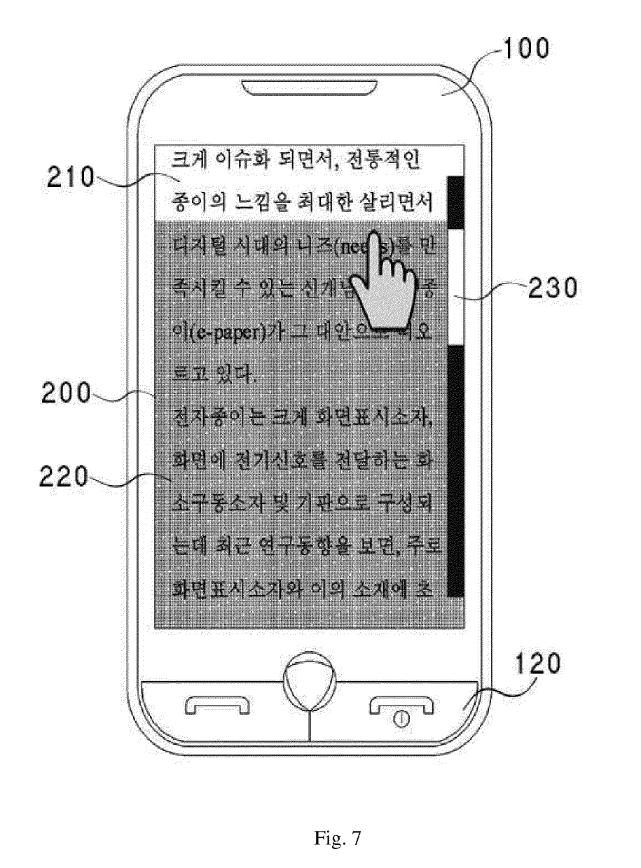

In FIGS. 6 and 7, a display unit 200 has a touch screen according to an embodiment of the present invention. A readable part 210 may be displayed on a top of the display unit 200 and the remaining may be a non-readable part 220. At this moment, if the display unit 200 is touched, letters in the non-readable part 220 may go up to the readable part 210. Going to the readable part 210 may be executed by touch and drag.

In some embodiments, when the non-readable part 220 is touched, an area of the readable part 210 may become large and an area of the non-readable part 220 may become narrow at the same time. A moving bar 230 may show a location of the readable part 210 displayed as its location in an entire electronic document.

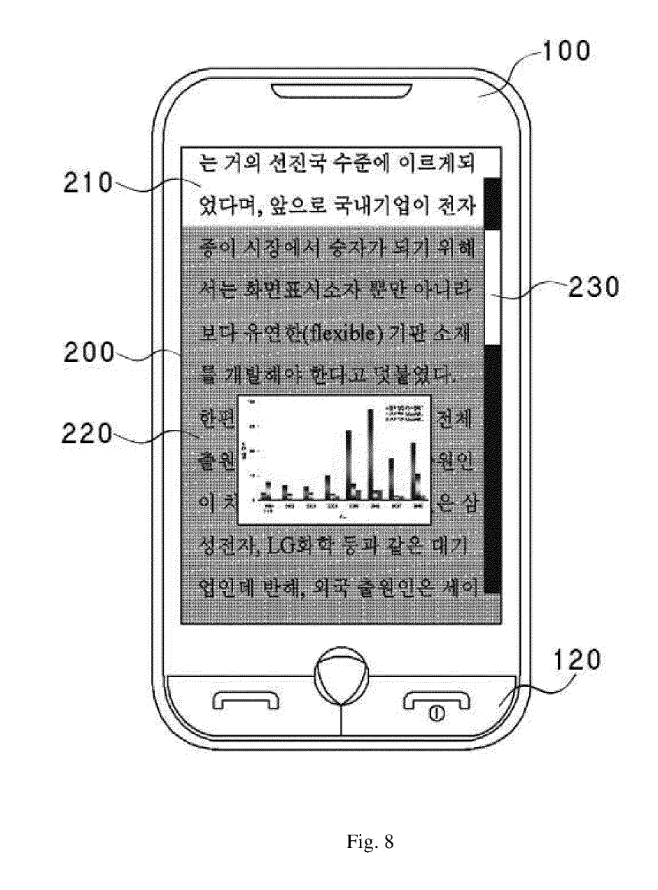

In FIG. 8, in some embodiments, the display unit 200 may display image files included in the non-readable part 220. That is, electronic documents, including image files, and audio files may be saved in a storage unit. Also such image files, and audio files may be matched with a specific letter or row. The matching row may be one row or more than one row. When a specific letter or row is displayed, a control unit may display image files matched with a specific letter or may output and execute sound files via a speaker. In this case, image files displayed in the non-readable part 220 may be clearly displayed and defined.

Therefore, a user can see image files conveniently without moving the moving bar 230 because the control unit displays image files matched with a specific letter according to a location of the readable part 210. The electronic documents displayed on the mobile terminal may be stored as files down-loaded in advance or data may be transmitted via wireless internet.

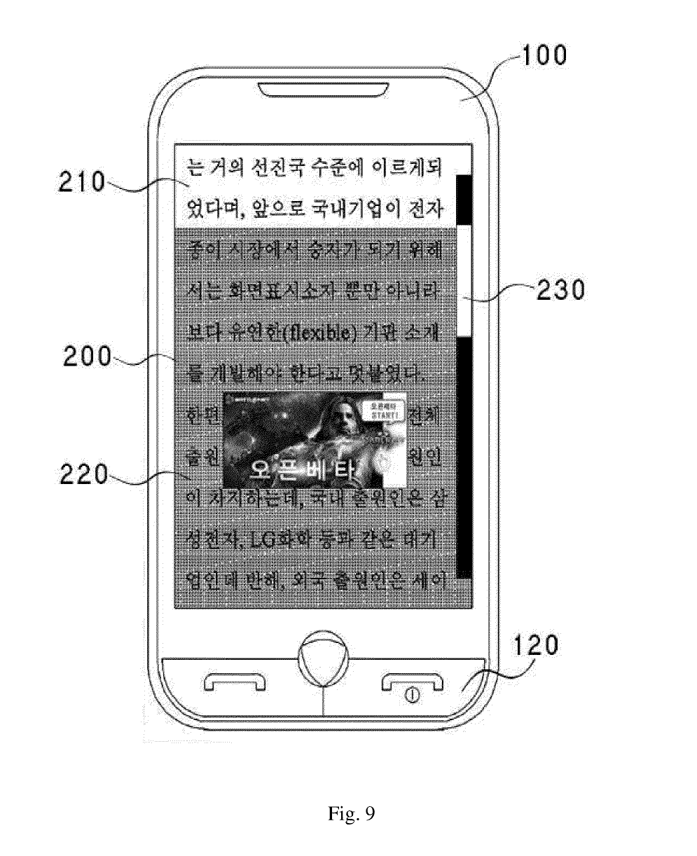

In FIG. 9, in some embodiments, contents service providers may make money by displaying some advertisements in the non-readable part 220. The contents service providers may earn money from advertisers who want to publish some advertisements in the electronic documents. Therefore readers of the electronic documents will be growing since some advertisements are provided to readers of the electronic documents freely or at low price.

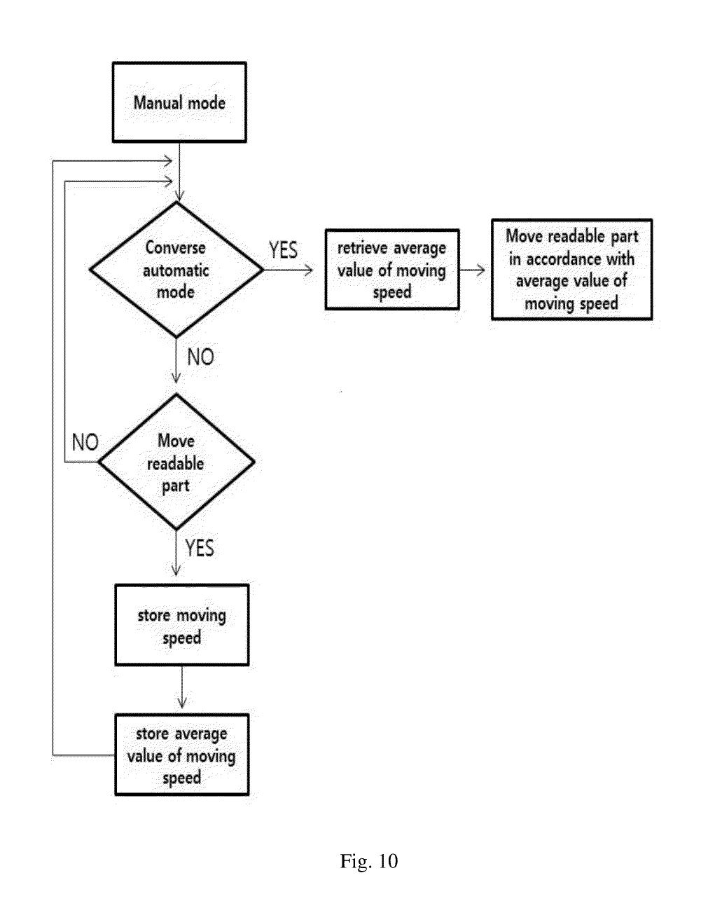

In some embodiments, the readable part 210 may move by a button or a user's touch, and also the movement of the readable part 210 may mean that letters in the non-readable part 220 move to the readable part 210 by any action of a user. However the movement of the readable part 210 by repetitive actions of a user may cause inconveniences. In FIG. 10, an automatic mode by which the readable part 210 moves automatically without a user's any input is described. In automatic mode, the readable part 210 may be moved by a control unit. In this case, the mobile terminal may provide a specialized function by using an adaptive automatic control method, responsive to a user's repeated movement, resulting from analyzing a usage pattern of a user. In manual mode, which may mean movement of the readable part by a user's input or action, the control unit may save timing data according to measuring and calculating a moving time of the readable part 210 in the storage unit, and the timing data is accumulated in the storage unit. Also, the control unit may measure and calculate a moving time of the readable part 210 based on the timing data saved in the storage unit. Also the average value may be measured and calculated differently and individually according to a type of letters. That is, the control unit may determine a type of letters displayed in the readable part, and measure and calculate the speed data based on time according to a type of languages because generally users have a different reading speed individually according to a type of languages, for example Hangul, English or Japanese. The movement of the readable part 210 may be moved continuously as well as discretely by scrolling. Continuous movements of the readable part 210 result in more gently scrolling.

In some embodiments, the mobile terminal may include a general mode in which the display unit 200 becomes the readable part 210 entirely and a shadow mode in which the display unit 200 may have the non-readable part 220 entirely or partly. If the shadow mode is executed, the display unit may be displayed with the readable part and the non-readable part, and accordingly users may move the readable part by a button key, moving bar(scroll bar). Also users may move the readable part by finger's touch on the readable part or the non-readable part. In shadow mode, the control unit may identify types of languages, for example Hangul, English or Japanese. Also the readable part may be displayed on a line of sentences.

In some embodiments, if users execute the automatic mode, the control unit may move the readable part at constant speed. The movement of the readable part means change of the sentences displayed in the readable part. The automatic mode may suspend temporarily by users' touch on the display or button press, and also moving speed of the readable part may be set up separately.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A mobile terminal comprising:
A storage unit storing an electronic document file;
A display unit displaying the electronic document file;
A control unit controlling the display of the electronic document file,
wherein the control unit controls the electronic document file to be displayed with a readable part able to be read clearly and a non-readable part unable to be read clearly.

2. The terminal of claim 1, wherein the non-readable part has a darkness clarity which is darker than that of the readable part.

3. The terminal of claim 1, wherein the non-readable part is displayed with reduced color difference between the environment part and the letters part than that of the readable part.

4. The terminal of claim 1, wherein letters in the readable part are bigger than those of the non-readable part.

5. The terminal of claim 1, wherein the display unit comprises touch screen, and a part or row where a touch is detected on the touch screen is changed into the readable part.

6. The terminal of claim 1, wherein the non-readable part displays an image file.

7. The terminal of claim 6, wherein the control unit controls an image file matched with a location of the readable part to be displayed.

8. The terminal of claim 1, wherein the control unit measures and calculates a moving speed of the non-readable part, and controls the readable part to be moved to another row in automatic mode which moves the readable part without user's input.

9. The terminal of claim 8, wherein the control unit, in manual mode which moves the readable part with a user's touch, measures and calculates a plurality of moving speeds of the readable part, and stores average value of the moving speeds of the readable part, and then moves the readable part in accordance with the average value of the moving speeds in automatic mode.

10. The terminal of claim 9, wherein the control unit stores the average value of the moving speeds separately according to types of languages, and then moves the readable part in accordance with the average values of the moving speeds according to types of languages in automatic mode.
